(19) United States
(12) Patent Application Publication
(10) Pub. No.: US 2006/0065627 A1
(43) Pub. Date: Mar. 30, 2006

(54) Processing electronic devices using a combination of supercritical fluid and sonic energy

(76) Inventors: James Clarke, Portland, OR (US); Kenneth C. Cadien, Portland, OR (US); Justin K. Brask, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,384

(22) Filed: Sep. 29, 2004

(51) Int. Cl. B44C 1/22; B08B 6/00; C23F 1/00

(52) U.S. Cl. 216/63; 216/17; 216/74; 134/1.2

(57) ABSTRACT

A method of processing a substrate. The method comprises flowing a supercritical fluid and a co-solvent across a substrate placed in a pressure tight vessel and applying a sonic energy to a surface of the substrate. The sonic energy can be an ultrasonic energy or a megasonic energy. The use of supercritical fluid and sonic energy can be used to clean a substrate, condition a surface of a substrate, to etch a substrate, to etch metal, to deliver materials to trenches and cavaties, and to selectively remove a polysilicon layer.

### FIELD

Embodiments of the present invention relate to using a combination of a supercritical fluid and sonic energy in one or more processes of making electronic devices such as semiconductor devices.

### BACKGROUND

As semiconductor device dimensions approach the nanoscale, it will become increasingly difficult to use aqueous-based cleaning processes due to high surface tension and capillary forces. Traditional wet cleaning and/or etching processes for semiconductor processing suffer from two distinct problems at future technology nodes. As the critical dimensions in a semiconductor process shrink, a wet chemical (aqueous or otherwise) must access smaller and smaller dimensions in order to clean effectively or to etch effectively. Currently, under conventional method, a wet chemical cannot effectively access small dimension features to perform its function in treating, cleaning and/or etching. Additionally, as feature dimensions decrease, the surface tension of a wet chemical would tend to cause pattern collapse. Moreover, as critical dimensions of semiconductor devices decrease, selective surface modification, ultra-small size particle removal, trench etching, trench filling, and photoresist residue removals become increasingly difficult.

### BRIEF DESCRIPTION OF THE DRAWINGS

The embodiments of the present invention are illustrated by way of example and not by way of limitation in the figures of the accompanying drawings in which like references indicate similar elements. The invention may best be understood by referring to the following description and accompanying drawings that are used to illustrate embodiments of the invention. It should be noted that references to “an” or “one” embodiment of the invention in this disclosure are not necessarily to the same embodiment, and they mean at least one. In the drawings:

FIG. 1 illustrates an exemplary method of processing a substrate using supercritical fluid and sonic energy;

FIG. 2 illustrates an exemplary chamber that can be used to carry out certain embodiments of the present invention;

FIG. 3 illustrates another exemplary chamber that can be used to carry out certain embodiments of the present invention;

FIGS. 4-6 illustrate an exemplary method of processing a semiconductor device where supercritical fluid and sonic energy are used to etch metal;

FIGS. 7-9 illustrate an exemplary method of processing a semiconductor device where supercritical fluid and sonic energy are used to polysilicon; and

FIGS. 10-14 illustrate an exemplary method of processing a semiconductor device where supercritical fluid and sonic energy are used to remove trench fill material.

### DETAILED DESCRIPTION

Exemplary embodiments are described with reference to specific configurations and techniques. Those of ordinary skill in the art will appreciate the various changes and modifications to be made while remaining within the scope of the appended claims. Additionally, well known elements, devices, components, circuits, process steps and the like are not set forth in detail.

Embodiments of the present invention pertain to uses of a supercritical fluid in conjunction with an application of a sonic energy to allow treating, cleaning, etching, or other processing of devices using wet chemistry. The combination of the supercritical fluid and sonic energy allow access to ultra-small dimension features (e.g., features of from about 25-30 nm or less) so that treating, cleaning, etching, removing residues, or particles from or of these features can be possible. The ability to access the ultra-small dimension features is especially useful in semiconductor processing as the critical dimension continues to decrease. Among many functions, treating may include cleaning a surface or a trench, etching a layer or a portion of a layer, etching a trench, filling a trench, modifying a layer or surface or a portion thereof, removing particles or residues off a substrate, or removing photoresist residues.

In one embodiment, a combination of a supercritical fluid and sonic energy is used to clean a substrate or remove particles off the substrate. A method according to the present embodiment comprises flowing a supercritical fluid and a co-solvent across a substrate placed in a pressure tight vessel and applying a sonic energy to a surface of the substrate. The sonic energy can be ultrasonic energy or megasonic energy, or the sonic energy can be of a frequency between 10-1500 kHz. The sonic energy can also be applied as pulses of energy. This method allows for cleaning of ultra-small particles off the substrate or the substrates' features. The supercritical fluid can be supercritical carbon dioxide. The co-solvent can be a cleaning fluid such as a cleaning gas or a cleaning solvent (e.g., hydrogen fluoride, hydrogen chloride, hydrogen peroxide, sulfuric acid, acetone, isopropanol alcohol, and ammonium hydroxide). The co-solvent can also be an etching fluid or a photoresist removal fluid typically used in semiconductor processing.

It has been seen that with the ultra-small particles of about 100 nm or less, on a surface or in a trench, the particles are trapped or held in the trench or at the surface by a static force so strong that no velocity or force of fluid will be able to remove the particles (this is mostly due to the boundary layer effect on the fluid, see below). This force increases as the size of the particles decreases. The use of the supercritical fluid increases the chance of removing or de-adhering the particles because the supercritical fluid experiences substantially little to no boundary layer effect. The supercritical fluid enhances the removal of the particles but to ensure that the particles are removed, sonic energy is used or pulsed of sonic energy is used.

Supercritical fluid (e.g., supercritical carbon dioxide) has gas-like diffusivity and viscosity and liquid-like densities, while being almost chemically inert. A host of chemically reactive agents are almost always used in conjunction during the use of supercritical fluid. A common supercritical fluid is carbon dioxide. Carbon dioxide becomes supercritical at temperatures above 30° C. and pressures above 1000 pounds per square inch. Supercritical fluid is known to have a low surface tension when flowing over a surface or into a trench, via, or crevice. There is a relatively small boundary layer in a supercritical fluid compared to other conventional fluid such as water, solvent, gas, etc. A boundary layer refers to the concept of fluid flowing across a surface or a pipe in which during such flowing, the velocity of the fluid is substantially less at the edges of the pipe or at the surface than the velocity of the fluid at the center or area above the surface. The existence of the boundary layer is due to an increase friction or other fluid dynamic factors affecting the fluid. But with a supercritical fluid, the boundary layer is substantially smaller or non-existence allowing for faster and uniform flow velocity.

Supercritical fluid alone could be used to clean the ultra-small particles or residues off a substrate but may not sufficiently remove the particles. Certain embodiments of the present invention apply sonic energy to the flow of the supercritical fluid that is used to clean the substrate. Sonic energy has been used in cleaning, etching, or removing of residues or particles in semiconductor processing. Sonic energy can lead to a lowering of the boundary layer (thickness) on the surface of a substrate. A direct result is an increase drag force on the substrate, which can act to remove the particles adsorbed to the surface of the substrate. As discussed above, the boundary layer effect on the surface refers to when fluid is flown across the surface, the velocity of the fluid is much slower in the area approximate or immediate to the surface than the area further from the surface. This boundary layer thickness is due to an increase in friction or other fluid dynamic facts affecting the flow of fluid.

Additionally, the sonic energy forms cavitation around the particle or particles and with the application of energy, causes the particles to be carried or shaken off the surfaces, trenches, or crevices and carried into the flow of the supercritical fluid. When sonic energy is applied, in between two peaks of energy, cavitation is formed. Cavitation is the formation or aggregation of gases dissolved in the fluid, that aggregate to form a gas bubble. The cavitation can form around a particle. Upon the next peak of energy or subsequent pulse of sonic energy, the bubble is broken and the energy is dissipated toward the surface adhesion (the static force), which holds the particle toward the surface. This dissipated or released energy is sufficient to overcome the static force and knock or release the particle free from the surface. The particle is thus swept into the flow of the fluid.

When the sonic energy is applied to the flow of the supercritical fluid, (optionally, in pulses of energy), the boundary layer effect dramatically decreases, surface tension also decreases, drag force increases, cavitation forms around the particles, and the static force holding the particles to the surfaces is overcome. The result is the efficient release and cleaning of the particles of the substrate surface, crevices, or trenches.

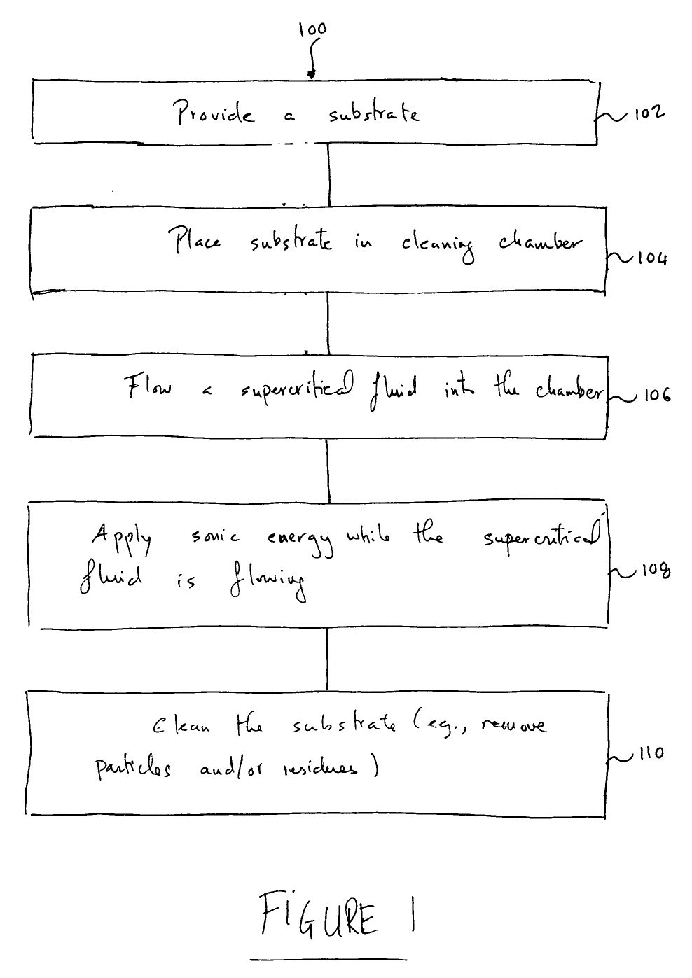

FIG. 1 illustrates an exemplary method 100 of cleaning particles of a substrate. At box 102, a substrate (e.g., a wafer, a semiconductor substrate, a silicon wafer, a silicon-on-insulator substrate, or silicon-germanium substrate) having structures or patterns formed thereon is provided. At box 104, the substrate is placed in a cleaning chamber, which could be a single wafer-cleaning chamber. The chamber is of the type that is a pressure tight vessel to allow it to hold a pressure for the fluid to be in its supercritical state. In one embodiment, the chamber is able to maintain a pressure of about 1000 pounds per square inch on the substrate. At box 106, a supercritical fluid (e.g., supercritical carbon dioxide) is introduced into the chamber. The supercritical fluid may be generated remotely or separately and supplied into the chamber. In one embodiment, the supercritical fluid flows across the surface of the substrate through an inlet provided in the chamber. In another embodiment, the supercritical fluid is introduced down onto the surface, for example, through a showerhead provided in the chamber. At box 108, while the supercritical fluid flows into the chamber, sonic energy is applied. The sonic energy can be applied by using a transducer placed in the chamber, for example, at the bottom of the chamber. The sonic energy can be applied to the supercritical fluid. The sonic energy can be applied to a space provided at the bottom of the substrate which will translate to the supercritical fluid. The sonic energy can be in the form of an ultrasonic energy (about 10-100 kHz) or a megasonic energy (about 700-1500 kHz). The sonic energy can also be applied in pulses of energy, in one embodiment. At box 110, the substrate is cleaned. In one embodiment, particles or residues are removed off the substrate.

In one embodiment, a co-solvent is mixed into the supercritical fluid. The co-solvent can be any solvent or fluid that is soluble in a supercritical fluid and that is suitable for cleaning the substrate. In one embodiment, an inert gas that is soluble in the supercritical fluid is introduced or mixed into the supercritical fluid. The inert gas provides dissolved gas in the supercritical fluid that acts as nucleation for the formation of the cavitation around the particles. Examples of the possible inert gas include argon (Ar), nitrogen (N₂) or xenon (Xe).

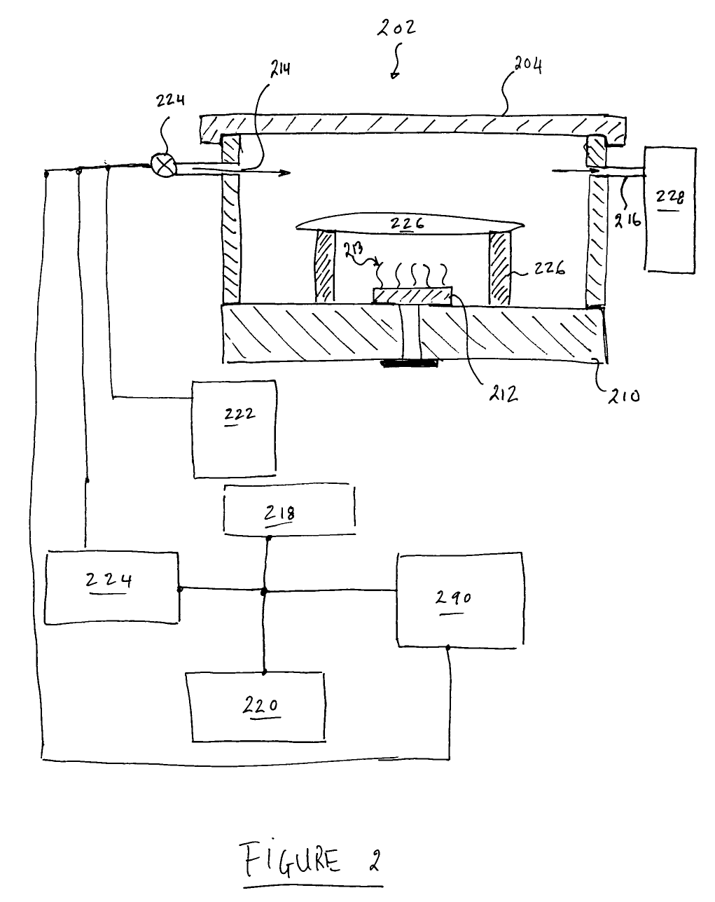

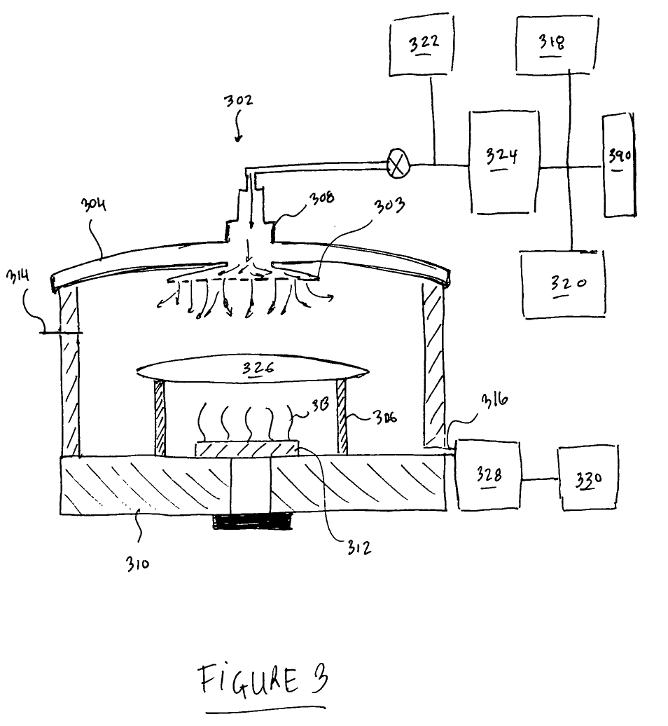

FIGS. 2-3 illustrate exemplary embodiments of a chamber that can be used for processing a substrate using a supercritical fluid and sonic energy. The chamber can be used for cleaning particles/residues off a substrate, etching a layer or portion of a layer, etching a trench, filling a trench, modifying a surface, removing a trench fill material, or removing photoresist residues.

In FIG. 2, a sealable chamber 202 is shown. The chamber 202 is a pressure tight vessel so as to maintain the chamber 202 at a particular pressure suitable for the supercritical fluid. In one embodiment, the chamber 202 is made of stainless steel. The chamber 202 includes a lid 204, a substrate support 206, a bottom platform 210, and a transducer 212 placed at the bottom of the chamber 202. High-pressure gaskets (not shown) may be used to couple the electronics of the transducer 212 to outside of the high-pressure chamber. The chamber 202 also includes an inlet 214 and an outlet 216 for the flow of the supercritical fluid, the co-solvent, and the inert gas in and out of the chamber 202. A co-solvent source 218, a supercritical fluid source 220, and an inert gas source 222 are connected to the inlet 214. The supercritical fluid may be generated separately in the supercritical fluid source 220 and supplied to the chamber 202. The co-solvent and the supercritical fluid are mixed together at the mixer 224 prior to being introduced into the chamber 202. Other configuration of the supercritical fluid and the co-solvent mix can be possible. Prior to being flown into the chamber 202, the supercritical fluid mixed with the co-solvent can also be mixed with an inert gas such as Ar, N2, or Xe contained in the inert gas source 222.

A substrate 226 is placed in the chamber 202 for processing. The substrate 226 can be a wafer having features, devices, or patterns formed thereon. To place the substrate 226 into the chamber 202, the lid 204 is opened. After the substrate 226 is placed on the support 206, the lid 204 is closed and the chamber 202 is sealed for processing. Appropriate processing parameters (e.g., temperature and pressure) are obtained and maintained. In the present embodiment, the supercritical fluid carrying the co-solvent and optionally, the inert gas, is introduced or flown into the chamber 202 via the inlet 214 and is flown across the substrate 226 to perform the appropriate treatment (e.g., cleaning, etching, or surface modifying). While the supercritical fluid, the co-solvent, and the inert gas are flowing across the substrate 226, the transducer 212 is turned on to generate the sonic energy 213 which translates to the fluids flowing across the substrate 226. The supercritical fluid carrying the co-solvent and the inert gas exit the chamber 202 via the outlet 216 as they flow across the substrate 226. A waste container 228 collects the fluids or agents that exit the chamber 202.

In one embodiment, a controller 290 is coupled to the chamber 202, the supercritical source 220, the co-solvent source 218, the mixer 224, and the inert gas source 222 to control the operation of the chamber 202 and the processes that take place in the chamber 202. For instance, the controller 290 controls the flow and introduction of the supercritical fluid, the co-solvent, the mixing of the supercritical fluid and the co-solvent, as well as the introduction and flow of the inert gas into the chamber 202. The controller 290 also controls the parameters for the chamber 202 such as temperature and pressure. The controller 290 may also control the processing time.

FIG. 3 illustrates another exemplary chamber that can be used to process a substrate in accordance to embodiments of the present invention. A sealable chamber 302 is shown; this chamber 302 is similar to the chamber 202 shown previously except that a showerhead 303 is included for the flow of the fluids into the chamber 302. The term “fluid” is used generally herein to refer to the supercritical fluid, the co-solvent, the inert gas, or other fluids as is known in the art that can be used for processing semiconductor devices.

The chamber 302 is a pressure tight vessel so as to maintain the chamber 202 at a particular pressure suitable for the supercritical fluid. In one embodiment, the chamber 302 is made of stainless steel. The chamber 302 includes a lid 304, a substrate support 306, a bottom platform 310, and a transducer 312 placed at the bottom of the chamber 302. High-pressure gaskets (not shown) may be used to couple the electronics of the transducer 312 to outside of the high-pressure chamber. The chamber 302 also includes a door 314 which can be used to insert or place a substrate into and out of the chamber 302. An outlet 316 is also included in the chamber 302 for the flow of fluids to exit out of the chamber 302. A co-solvent source 318, a supercritical fluid source 320, and an inert gas source 322 are connected to an inlet 308, which communicates with the showerhead 303 for the injection of the fluids into the chamber 302. The supercritical fluid may be generated separately in the supercritical fluid source 320 and supplied to the chamber 302. The co-solvent and the supercritical fluid are mixed together at the mixer 324 prior to being introduced into the chamber 302. Other configuration of the supercritical fluid and the co-solvent mix can be possible. Prior to being flown into the chamber 302, the supercritical fluid mixed with the co-solvent can also be mixed with an inert gas such as Ar, N2, or Xe contained in the inert gas source 322.

A substrate 326 is placed in the chamber 232 for processing. The substrate 326 can be a wafer having features, devices, or patterns formed thereon. To place the substrate 326 into the chamber 302, the door 314 is opened. After the substrate 326 is placed on the support 306, the door 314 is closed and the chamber 302 is sealed for processing. Appropriate processing parameters (e.g., temperature and pressure) are obtained and maintained. In the present embodiment, the supercritical fluid carrying the co-solvent and optionally, the inert gas is flown into the chamber 302 via the inlet 308 and is flown down through the showerhead 303 and distributed onto the substrate 326. While the supercritical fluid, the co-solvent, and the inert gas are flowing across the substrate 326, the transducer 312 is turned on to generate the sonic energy 313 which translates to the fluids flowing across the substrate 326. The supercritical fluid carrying the co-solvent and the inert gas exit the chamber 302 via the outlet 316. A waste container 328 collects the fluids that exit the chamber 302. A pump 330 may be connected to the waster container 328 to facilitate the drawing of the fluids out of the chamber 302.

In one embodiment, a controller 390 is coupled to the chamber 302, the supercritical source 320, the co-solvent source 318, the mixer 324, and the inert gas source 322 to control the operation of the chamber 302 and the processes that take place in the chamber 302. For instance, the controller 390 controls the flow and introduction of the supercritical fluid, the co-solvent, the mixing of the supercritical fluid and the co-solvent, as well as the introduction and flow of the inert gas into the chamber 302. The controller 390 also controls the parameters for the chamber 302 such as temperature and pressure. The controller 390 may also control the processing time.

Besides treating a substrate using a supercritical fluid and sonic energy to clean/remove particles/residues off the substrate, the supercritical fluid and sonic energy can be used for other substrate treatment, for instance, surface conditioning. In several embodiments, the supercritical fluid and the sonic energy are used for surface conditioning in the device fabrication processes. Surface conditioning refers to changing the molecular surface termination of a substrate or a surface such as changing the chemistry so that the surface contains hydrophobic or hydrophilic terminations or certain polarity termination. The use of a supercritical fluid will allow an active co-solvent to access features or surfaces on a substrate more easily so as to modify or treat the surface. The use of sonic energy breaks up the bond of the existing terminations on the surface so as to allow for easy and efficient exchange of new termination groups.

For instance, the use of a supercritical fluid as a carrier for an active solvent to treat a surface while sonic energy is applied facilitates changing features such as changing from one material to another material, changing a polysilicon gate electrode to a metal gate electrode or etching of features such as etching away unreacted metal. Additionally, the use of supercritical fluid to carry an active solvent to treat a surface while sonic energy is applied can be used to change a hydrophobic termination group to a hydrophilic termination group, or vice versa. In these embodiments, the appropriate co-solvent for the termination group exchanging is mixed with the supercritical fluid and flown into the chamber as previously described to treat a substrate while sonic energy is applied.

In one embodiment, a supercritical fluid and sonic energy are used to etch metal. In a variety of different circumstances, it may be desirable to selectively etch metal in the fabrication of a semiconductor device. For example, the etching of metal may be related to the formation of a metal silicide layer (e.g., a nickel silicide layer), a layer used to reduce metal-to-semiconductor contact resistances in a semiconductor device.

Accordingly, in one embodiment, a method of etching metal in accordance to the present invention comprises obtaining a device substrate having a metal feature disposed thereon and etching at least a portion of the metal using a supercritical fluid mixed with an etching fluid while applying sonic energy to the supercritical fluid mixed with the etching fluid. In one embodiment, the etching fluid is an oxidant-free etching fluid.

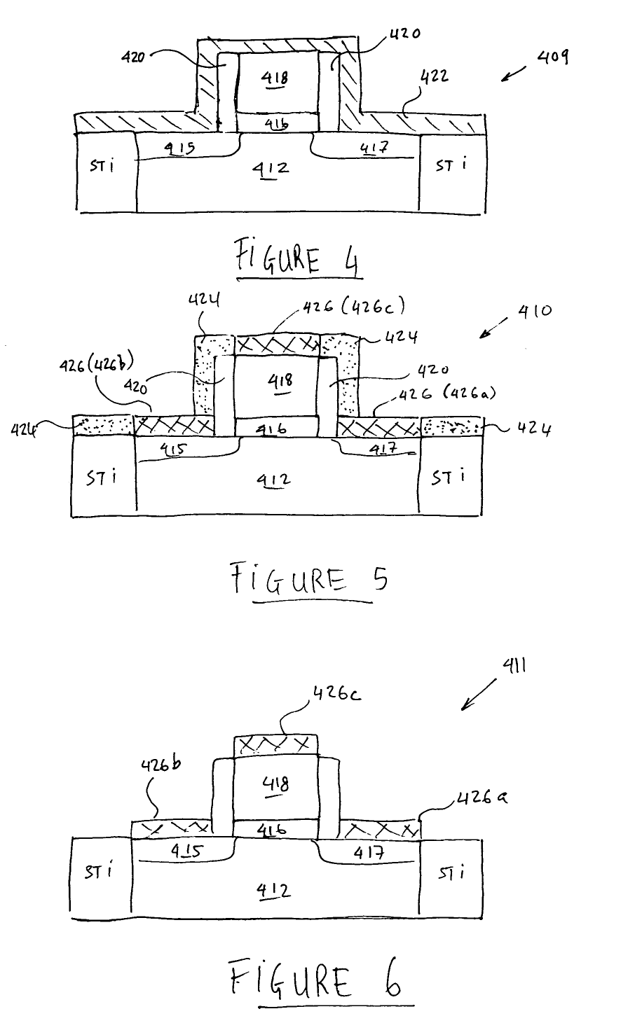

To form a metal silicide layer, a metal layer (nickel, for example) typically is deposited on a semiconductor structure. Although the present embodiment discusses using nickel for the formation of the metal silicide, other metals can be used to form metal silicide in accordance to the scope of the present embodiment. In this manner, the deposited metal reacts with exposed silicon of the structure to form the metal silicide layer. Not all of the deposited metal layer typically reacts. The regions in which the metal layer does not react form excess or un-reacted metal regions that typically are removed by wet etching. As a more specific example, FIG. 4 depicts a semiconductor structure 409 that represents a particular stage in a process to form a complimentary metal oxide semiconductor (CMOS) transistor. In the present embodiment, it is assumed that the CMOS transistor is formed on a silicon substrate 412. As shown in FIG. 4, a polysilicon gate 418 resides on top of a gate oxide layer 416, and vertically extending nitride spacers 420 may be located on either side of the polysilicon gate 418.

For purposes of creating a nickel silicide layer, a nickel layer 422 may be blanket deposited over existing layers of the structure 409. As depicted in FIG. 4, the deposited nickel layer 422 extends over portions of the silicon substrate 412 as well as extends over the polysilicon gate 418. The regions in which the nickel layer 422 contacts the silicon substrate 412 form parts of the source 415 and drain 417 of the transistor, and the region in which the nickel layer 422 contacts the polysilicon gate 418 forms part of the gate of the transistor in this embodiment.

Thus, the deposited nickel layer 422 contacts the polysilicon gate 418 and the silicon substrate 412, and in these contacted regions, the nickel layer 422 reacts with the polysilicon gate 418 and the silicon substrate 412 to form the nickel silicide layer that extends into regions 426 of a resulting structure 410 that is depicted in FIG. 5. As a more specific example, a particular nickel silicide region 426a may be associated with a drain 417 of the transistor, another nickel silicide region 426b may be associated with a source 415 of the transistor, and another nickel silicide region 426c may be associated with a gate 418 of the transistor.

The deposited nickel does not react everywhere, leaving regions 424 of excess or unreacted nickel. To remove these regions 424, selective etching using a supercritical fluid (carrying an active co-solvent) and sonic energy is used to target the nickel but not other substances (such as nickel silicide, for example) to remove the nickel to form a structure 411 that is depicted in FIG. 6. Thus, after the selective etching, the unreacted nickel portions 424 (see FIG. 5) are removed, leaving only the regions 426 of nickel silicide film, as depicted in FIG. 6.

In the present embodiment, to remove the unreacted metal, a supercritical fluid is mixed with an etching fluid and disposed over the substrate 412 while sonic energy is being applied. The processing chambers previously described can be used for the etching process to remove the unreacted metal. Thus, in the present embodiment, the substrate 412 is placed in the chamber (e.g., chamber 202 or 302) which is then sealed. The supercritical fluid (e.g., supercritical carbon dioxide) is mixed with an etching fluid that is soluble in the supercritical fluid and that can etch metal such as sulfuric acid. An inert gas may be added to the mixture of the supercritical fluid and the etching fluid. The fluids are then introduced into the chamber as previously described. Sonic energy is applied into the chamber while the supercritical fluid and the etching fluid are being introduced into the chamber. The sonic energy can be applied in pulses and can be frequency ranges in the ultrasonic range (e.g., 10-100 kHz) or the megasonic range (e.g., 500-1500 kHz).

One advantage of using the present embodiment to etch away the unreacted metal is that the supercritical fluid with the combination of the sonic energy enable the etching fluid to get to surface of the substrate and the unreacted metal in order to remove the unreacted metal. The combination also allows the etching fluid to access ultra-small features that are not typically accessible using the conventional solvent. Additionally, some etching fluid lacks an oxidant and cannot by itself be sufficient to etch certain metal such as nickel due to the potential energy barrier that exists for dissolving nickel. For certain semiconductor devices, the presence of an oxidant in the etching fluid may undesirably oxidize and thus, etch substances that are not meant to be etched. For instance, in a semiconductor device where germanium is included in the substrate, an oxidant may etch some of the germanium at relatively the same rate as the unreacted metal or nickel. Thus, the etching fluid for such devices should not include an oxidant. However, an oxidant has been used with conventional etching fluid to allow for the dissolution of the unreacted metal. With the embodiments of the present invention, which use the application of the sonic energy and the supercritical fluid, the etching fluid can access and dissolve the metal without the oxidant.

In one embodiment, a supercritical fluid and sonic energy are used to etch polysilicon. In a variety of different circumstances, it may be desirable to etch polysilicon selectively. That is, it may be desirable to preferentially etch polysilicon while reducing the etching of other materials.

One example of a situation where such selective etching may be desirable is in connection with providing dual metal gate technology. Dual polysilicon gates are used in conventional complementary metal oxide semiconductor (CMOS) devices to engineer a desired threshold voltage that may be different between the NMOS and PMOS devices. Unfortunately, as the device's scale becomes smaller, this approach is not effective. When the polysilicon doping level is not sufficiently high, the polysilicon gate depletion effectively increases the gate dielectric thickness by several Angstroms. This negatively impacts the ability to scale gate dielectric thicknesses. Boron penetration and gate resistance may also be issues for such polysilicon gate technology.

One approach to this problem is to replace the polysilicon gate with a metal gate. More particularly, one metal gate may be utilized for the NMOS devices and a different metal gate may be utilized for the PMOS devices.

In one embodiment, a method of removing a polysilicon layer or gate in accordance to the present invention comprises obtaining a device substrate having a polysilicon layer disposed thereon and etching at least a portion of the polysilicon using a supercritical fluid mixed with an etching fluid while applying sonic energy to the supercritical fluid mixed with the etching fluid. The sonic energy can be an ultrasonic energy or a megasonic energy. The etching fluid selected is one that is selective to remove the polysilicon layer without removing other layers. A metal layer is formed in the portion where the polysilicon layer is etched away.

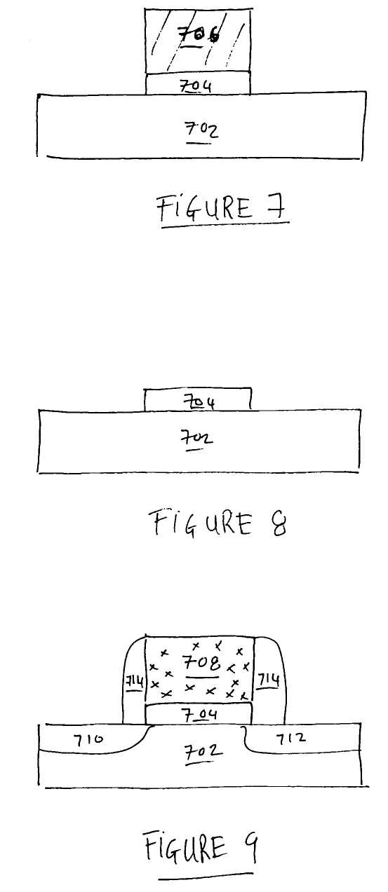

In one embodiment, (FIGS. 7-9), a substrate 702 is provided. A gate dielectric 704 is formed on the substrate 702. A polysilicon gate 706 is formed on the gate dielectric 704 (FIG. 7). At least a portion or all of the polysilicon gate 706 is then etched away (FIG. 8) using a supercritical fluid mixed with an etching fluid while applying sonic energy to the supercritical fluid mixed with the etching fluid similar to previously described. A metal gate 708 is then formed over the portion of polysilicon gate 706 that has been etched (FIG. 9). The sonic energy can be an ultrasonic energy or megasonic energy. The etching fluid is one that is selective to remove the polysilicon gate 706. Examples of suitable etching fluids include chlorine, tetramethylammonium (TMAH), and ammonium hydroxide (NH₄OH). The etching fluid should be one that is soluble in the supercritical fluid (e.g., supercritical carbon dioxide in one embodiment). In one embodiment, an inert gas is mixed into the supercritical fluid and the etching fluid.

In the present embodiment, to remove the polysilicon gate 706, the supercritical fluid is mixed with the etching fluid and disposed over the substrate 702 while sonic energy is being applied. The processing chambers previously described can be used for the etching process to remove the polysilicon gate. Thus, in the present embodiment, the substrate 702 is placed in the chamber (e.g., chamber 202 or 302) which is then sealed. The supercritical fluid (e.g., supercritical carbon dioxide) is mixed with the etching fluid that is soluble in the supercritical fluid and that can selectively etch polysilicon. An inert gas may be added to the mixture of the supercritical fluid and the etching fluid. The fluids are then introduced into the chamber as to previously described. Sonic energy is applied into the chamber while the supercritical fluid and the etching fluid are being introduced into the chamber. The sonic energy can be applied in pulses and can be frequency ranges in the ultrasonic range (e.g., 10-100 kHz) or the megasonic range (e.g., 500-1500 kHz).

In one embodiment, after the polysilicon gate 706 is removed and the metal gate 708 is formed, other features for the device (e.g., source and drain regions 710 and 712 and sidewall spacers 714) can be formed to complete the device using methods known in the art.

In one embodiment, a supercritical fluid and sonic energy are used to remove material from trenches. In a variety of different circumstances, it may be desirable to remove material from trenches. When trenches are extremely narrow and have high aspect ratios, it is extremely difficult to remove materials from the trenches using conventional wet etch. Under the current practice, only the very upper portion of the trench material is removed. The etchant does not penetrate downwardly sufficiently to remove all of the material from the trench.

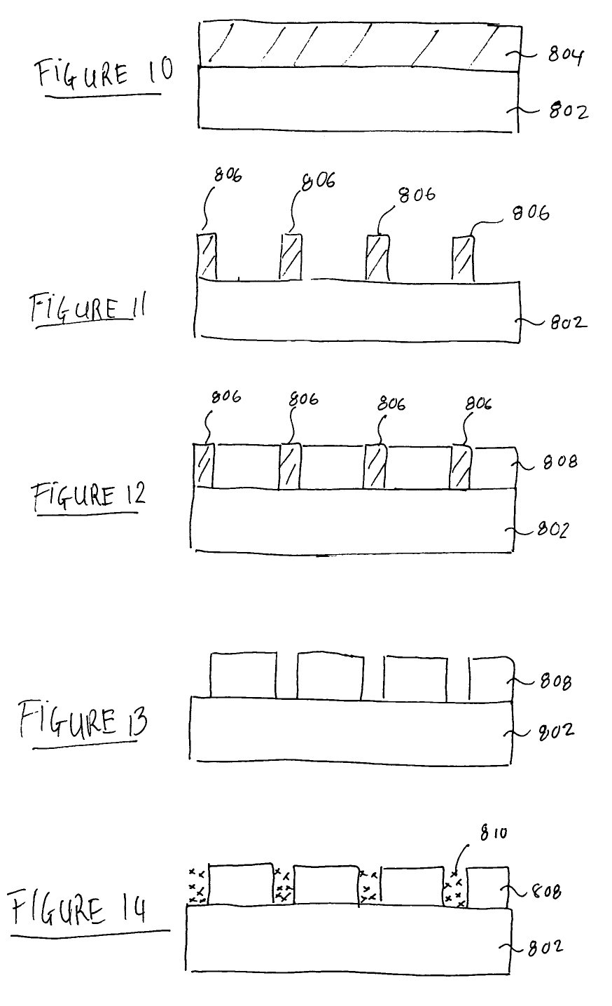

In some embodiments, a trench is filled with a trench filler material through the process of making the device. The trench may initially be filled with a material as a place holder. In one embodiment, a substrate 802 is first provided. There are many processes that are currently used to form trenches and fill the trenches with place holder type of material (that are later on removed). In one instance, a polysilicon 804 is blanket deposited over a substrate 802 as shown in FIG. 10. The polysilicon 804 may then be dry etched and patterned to form relatively narrow lines 806 (FIG. 11). An interlayer dielectric 808 may be formed and polished to expose the polysilicon lines 806 (FIG. 12). At this point, the polysilicon lines 806 then amount to a trench filler in trenches are effectively defined within the interlayer dielectric 806. At this point, the polysilicon filler material 804 may then be removed using the supercritical fluid and a suitable etching fluid (that can remove the trench filler material and that is soluble in the supercritical fluid) to give the structure 800 shown in FIG. 13. The substrate 802 is exposed to a supercritical fluid mixed with an etching fluid; and while the substrate 802 is exposed to the supercritical fluid mixed with the etching fluid, sonic energy is applied to the supercritical fluid mixed with the etching fluid. Such exposure removes material used to fill the trench. The trench 803 may have a width of 25-30 nanometers or less and an aspect ratio of depth to width of at least four to one. The trench 803 is then filled with another desirable material 810 (FIG. 14).

Similar to previously described, the substrate 802 may be placed in the processing chambers previously described (e.g., chamber 202 or 302). The supercritical fluid (e.g., supercritical carbon dioxide) is mixed with the etching fluid that is soluble in the supercritical fluid and that can etch the trench filler material (e.g., polysilicon). An inert gas may be added to the mixture of the supercritical fluid and the etching fluid. The fluids are then introduced into the chamber similar to previously described. Sonic energy is applied into the chamber while the supercritical fluid and the etching fluid are being introduced into the chamber. The sonic energy can be applied in pulses and can be frequency ranges in the ultrasonic range (e.g., 10-100 kHz) or the megasonic range (e.g., 500-1500 kHz).

The sonic energy breaks up capillary forces, surface tensions and concentration gradient differentials to enable effective etching of the trench fill material in narrow trenches. Additionally, the supercritical fluid lower the surface tensions and reduces the barrier layer to enable the etching fluid to get into the narrow trenches to enable etching of the trench fill material.

While the invention has been described in terms of several embodiments, those of ordinary skill in the art will recognize that the invention is not limited to the embodiments described. The method and apparatus of the invention, but can be practiced with modification and alteration within the spirit and scope of the appended claims. The description is thus to be regarded as illustrative instead of limiting.

Having disclosed exemplary embodiments, modifications and variations may be made to the disclosed embodiments while remaining within the spirit and scope of the invention as defined by the appended claims.

We claim:

1. A method of processing a substrate comprising:
flowing a supercritical fluid and a co-solvent across a substrate placed in a pressure tight vessel; and
applying a sonic energy to a surface of the substrate.

2. The method of processing a substrate of claim 1 wherein the sonic energy is one of ultrasonic energy and megasonic energy.

3. The method of processing a substrate of claim 1 further comprising:
mixing an inert gas into the supercritical fluid.

4. The method of processing a substrate of claim 1 further comprising:
cleaning ultra-small particles off the substrate.

5. The method of processing a substrate of claim 1 wherein applying the sonic energy includes forming cavitation around one or more particles on the substrate to facilitate removal of the particles off the substrate.

6. The method of processing a substrate of claim 1 wherein applying the sonic energy includes pulsing the sonic energy.

7. A method of cleaning particles off a substrate comprising:
placing a substrate in a pressure tight vessel, the vessel including a transducer and a substrate support, the substrate being placed on the substrate support;
flowing a supercritical fluid mixed with a co-solvent into the vessel;
applying a sonic energy to a surface of the substrate using the transducer;
causing cavitation around one or more particles; and
removing the particles off the substrate.

8. The method of cleaning particles off a substrate as in claim 7 wherein flowing the supercritical fluid mixed with the co-solvent includes any one of flowing the supercritical fluid mixed with the co-solvent across a surface of the substrate and flowing the supercritical fluid mixed with the co-solvent down onto a surface of the substrate.

9. The method cleaning particles off a substrate of claim 7 further comprising:
mixing an inert gas into the supercritical fluid.

10. The method of cleaning particles of a substrate of claim 7 wherein the sonic energy is one of ultrasonic energy and megasonic energy.

11. A method comprising:
obtaining a device substrate having a metal feature disposed thereon;
etching at least a portion of the metal using a supercritical fluid mixed with an etching fluid while applying sonic energy to the supercritical fluid mixed with the etching fluid.

12. The method of claim 11 further comprising:
depositing a metal layer on the device substrate, the metal layer forming reacted and unreacted metal regions, wherein the etching includes etching at least a portion of the unreacted metal regions.

13. The method of claim 11 wherein the sonic energy is one of ultrasonic energy and megasonic energy.

14. The method of claim 11 wherein the etching fluid is an oxidant-free etching fluid.

15. The method of claim 11 further comprising:
mixing an inert gas into the supercritical fluid.

16. The method of claim 11 wherein the etching further comprising:
placing the device substrate in a pressure tight vessel, the vessel including a transducer and a substrate support, the device substrate being placed on the substrate support;
flowing the supercritical fluid mixed with the etching fluid into the vessel while applying the sonic energy to a surface of the device substrate using the transducer.

17. A method comprising:
obtaining a device substrate having a polysilicon layer disposed thereon;
etching at least a portion of the polysilicon using a supercritical fluid mixed with an etching fluid while applying sonic energy to the supercritical fluid mixed with the etching fluid.

18. The method of claim 17 further comprising:
depositing a metal layer on the device substrate over at least the portion of polysilicon that is etched.

19. The method of claim 17 wherein the sonic energy is one of ultrasonic energy and megasonic energy.

20. The method of claim 17 wherein the etching fluid is selective to remove the polysilicon layer.

21. The method of claim 17 further comprising:
mixing an inert gas into the supercritical fluid.

22. The method of claim 17 wherein the etching further comprising:
placing the device substrate in a pressure tight vessel, the vessel including a transducer and a substrate support, the device substrate being placed on the substrate support;
flowing the supercritical fluid mixed with the etching fluid into the vessel while applying the sonic energy to a surface of the device substrate using the transducer.

23. A method of fabricating a semiconductor device comprising:
providing a substrate;
forming a gate dielectric on the substrate;
forming a polysilicon gate on the gate dielectric;
etching at least a portion of the polysilicon gate using a supercritical fluid mixed with an etching fluid while applying sonic energy to the supercritical fluid mixed with the etching fluid; and
forming a metal gate over the portion of polysilicon gate that has been etched.

24. The method of claim 23 wherein the sonic energy is one of ultrasonic energy and megasonic energy.

25. The method of claim 23 wherein the etching fluid is selective to remove the polysilicon gate.

26. The method of claim 23 further comprising:
mixing an inert gas into the supercritical fluid.

27. The method of claim 23 wherein the etching further comprising:
placing the substrate in a pressure tight vessel, the vessel including a transducer and a substrate support, the device substrate being placed on the substrate support;
flowing the supercritical fluid mixed with the etching fluid into the vessel while applying the sonic energy to a surface of the device substrate using the transducer.

28. A method comprising:
obtaining a substrate having a filled trench;
exposing the substrate to a supercritical fluid mixed with an etching fluid; and
while the substrate is exposed to the supercritical fluid mixed with the etching fluid, applying sonic energy to the supercritical fluid mixed with the etching fluid, wherein the exposing removes material used to fill the trench.

29. The method of claim 28 wherein the exposing further comprising:
placing the substrate in a pressure tight vessel, the vessel including a transducer and a substrate support, the device substrate being placed on the substrate support;
flowing the supercritical fluid mixed with the etching fluid into the vessel while applying the sonic energy to a surface of the substrate using the transducer.

30. The method of claim 29 wherein flowing the supercritical fluid mixed with the etching fluid includes any one of flowing the supercritical fluid mixed with the etching fluid across a surface of the substrate and flowing the supercritical fluid mixed with the etching fluid down onto a surface of the substrate.
